(19) United States
(12) Patent Application Publication
(10) Pub. No.: US 2006/0015923 A1
(43) Pub. Date: Jan. 19, 2006

(54) Collaborative interactive services synchronized with real events

(76) Inventors: Mei Chuah, Mountain View, CA (US); Lucian P. Hughes, Montara, CA (US)

Correspondence Address: ACCENTURE CHICAGO 28164;BRINKS HOFER GILSON & LIONE, P O BOX 10395, CHICAGO, IL, 60610, US

(21) Appl. No.: 10/235,031

(22) Filed: Sep. 3, 2002

(51) Int. Cl. H04N 7/173; H04N 7/16

(52) U.S. Cl. 725/135; 725/105

(57) ABSTRACT

A collaborative interactive service is provided. Event messages are automatically generated and provided to a plurality of user devices via a networked communication environment, based on events of a subset of particular episodes of a plurality of episodes. User messages are received from the user devices via the networked communication environment, responsive to the generated event-based messages, and the received user messages are correlated to the events. The event messages are generated and provided based, in addition, on the user messages received and correlated. Association messages are received from the plurality of user devices, and the association messages are processed to determine the plurality of user devices and the subset of particular episodes.

### TECHNICAL FIELD

The present invention is in the field of collaborative interactive services and, in particular, relates to an architecture for providing collaborative interactive services in association with real events.

### BACKGROUND

Interactive television (known as “iTV”), which provides services such as games, banking and shopping, has not been widely adopted. It is believed that three primary reasons that adoption of iTV has been limited thus far are availability, price, and functionality. That is, iTV services typically require a special set-top box or other special hardware at each subscriber's home. Additionally, the service providers in a particular geographic area typically must make an investment in “central office” infrastructure to deliver the iTV services to, the subscribers. These affect both price and availability. Furthermore, the services offered thus far have apparently not been particularly interesting to potential subscribers—or, at least, interesting enough when balanced against the cost and trouble to obtain the services.

### SUMMARY

A collaborative interactive service is provided. Event messages are automatically generated and provided to a plurality of user devices via a networked communication environment, based on events of a subset of particular episodes of a plurality of episodes. User messages are received from the user devices via the networked communication environment, responsive to the generated event-based messages, and the received user messages are correlated to the events. The event messages are generated and provided based, in addition, on the user messages received and correlated. Association messages are received from the plurality of user devices, and the association messages are processed to determine the plurality of user devices and the subset of particular episodes.

### BRIEF DESCRIPTION OF THE DRAWINGS

FIG. 1 illustrates an example interactive collaborative session where the episode is a sports episode.

FIG. 2 illustrates an example architecture to accomplish an interactive collaborative session.

FIG. 3 illustrates an example interactive collaborative session where the episode is music-related.

### DETAILED DESCRIPTION

By contrast to iTV, Instant Messaging (IM) has been very widely adopted. By one estimate, IM services have a user base of 130 million people on public servers alone. Furthermore, there are a significant number of enterprise users. Despite the popularity of IM, the IM environment today is very sterile.

This can be especially seen by contrasting IM chat to “real world” chat, where the people communicating are in physical proximity to each other and speaking directly with each other. People in the real world are surrounded by fascinating, dynamic, colorful content. For example, a person may be in a cafe watching crowds pass and street musicians entertain. As another example, a person may be in a stadium watching an exciting sports game unfold. As yet another example, a person may be resting at home, watching a favorite drama on television.

This real world content is not incorporated into conventional IM systems. In accordance with an aspect of the invention, “reality streams” are injected into the IM environment. This significantly enhances user experience and enables a broad range of new services.

As discussed above, IM is widely deployed. Unlike iTV, IM already has a very compelling functionality that draws a large number of users—chat. By delivering iTV-type services through IM, consumers are much more accessible than they are just through the television set. IM operates on a large range of pervasive devices including the cellular phone, PDAs, tablets, laptops, and desktops. This enables consumers to access IM services wherever they are, whether at home watching a sports event on television with their web-enabled laptop or desktop computer or at a sports stadium with their IM-enabled cellular phones. Not only can consumers access relevant services that are synched to their current environment, wherever they may be, but such access is within their existing TM social context.

We now discuss some example scenarios that illustrate the use of IM to deliver enhanced services. We first describe the use of IM to provide a play-by-play sports competition service, synched to user activity. We then describe synching user activity using IM to generate revenue from sales of products (e.g., impulse purchases such as music CDs, DVDs, toys). Then we describe examples of some additional functions enabled by IM technology, and explore an expanded view of the “real world” to which the IM services may be synched.

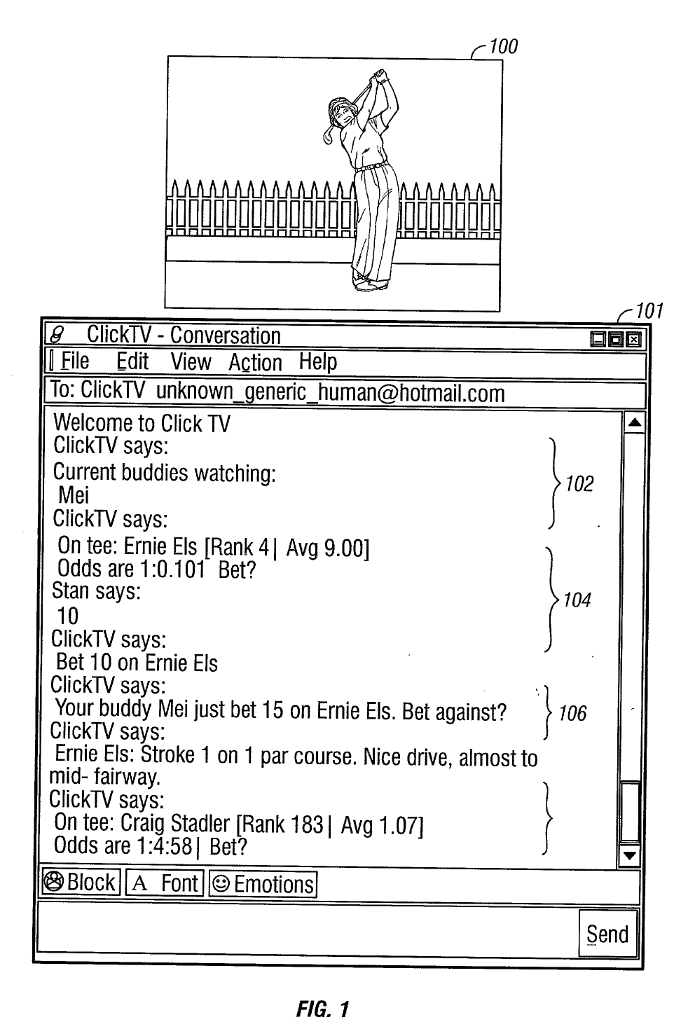

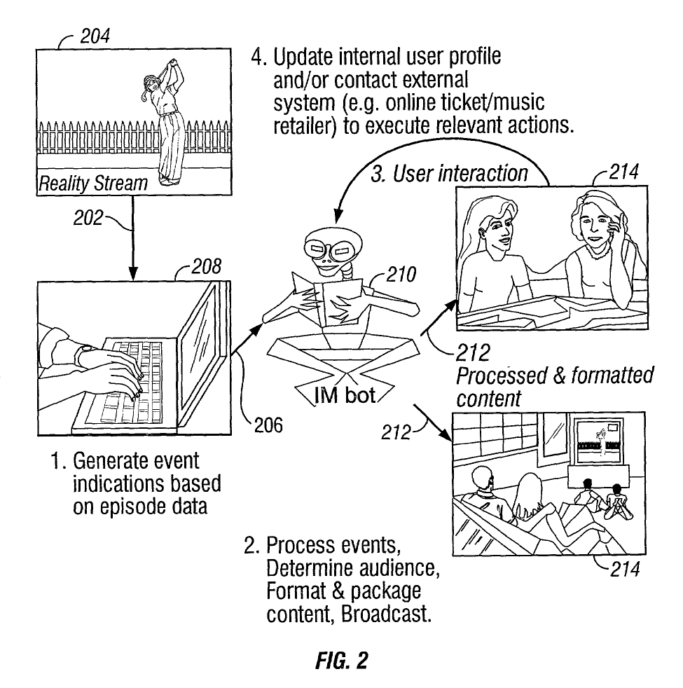

FIG. 1 illustrates a play-by-play interactive sports service in accordance with an example, from a user's point of view. FIG. 2 illustrates the sports service from an architecture point of view. Watching sporting events is widespread, real-time, and “lean forward.” That is, it encourages audience participation. This example service can be provided via IM in a non-intrusive always on channel that, for example, phone communication does not provide. By synching real-world sports episodes to IM, the IM social environment is enhanced, increasing users' awareness of friends' activities. That is, not only does a user know that his friends are online, but the user also knows that his friends are watching the very same live competitive sports game as the user and the user can interact with his friends, via IM, with respect to the sports game.

Turning now specifically to FIG. 1, a user viewing a golf game 100 may associate with a game bot (described more fully later, with reference to FIG. 2) corresponding to the golf game 100. In one example, the user associates with the game bot merely by opening a chat conversation with the game bot. It is necessary, in some examples, for the user to have previously subscribed to the game bot by, for example, providing relevant personal information about the user to the game bot. (Alternately, the game bot may have received relevant personal information via other channels, such as from the user's profile maintained by a sports information subscription site.) The user receives, in an IM session 101, a list 102 of users on the user's IM buddy list who are also currently associated with the game bot. Furthermore, the other users who have the user on their buddy list may receive an announcement that the user has become associated with the game bot. Processing the buddy list in view of the user's particular associations enables a new notion of “buddy surfing.” Buddy surfing allows a user to quickly skim through different channels of real time content and check not just what content is currently available, but also which individuals in the buddy list are associated with the different channels.

In addition to associating the real time sports episode to the IM social network, interactivity is provided. Referring still to the FIG. 1 example, the IM session 101 is synched to the real-time golf episode 100 on a play-by-play event basis. As events occur in the golf episode 100, indications of the events are transmitted to each associated user's IM session 101. In a basic example, the indications are transmitted as text. In other examples, the indications are transmitted as audio (voice) or video.

In some examples, a user may interact based on the indications, as desired. For example, when a new player comes up to tee for a particular hole, an indication of this event is provided to each associated user's IM session 101, and the users may provide a guess as to whether that player will be able to meet par for the hole. (See element 104 in FIG. 1.) Based on the guesses and actual events (in this example, the number of strokes it takes the player to reach the hole), a score is maintained for each associated user. In one example, once play on a hole has begun, users may still interact at any time they choose, for example, to send a cancellation message. A cancellation may incur a certain score penalty, where the size of the score penalty depends on the lateness of the cancellation as well as the current status of the play for the hole. Users can socialize and compete for points continuously throughout the golf episode 100. However, participation is not required. Users may interact with the service, or choose to stay passive and let the messages scroll by, focus on the game, and only participate occasionally if at all.

In accordance with the FIG. 1 example, the interactive game is tied into the social context of the users. In particular, whenever a user interacts with the service, an indication of the interaction may be broadcast to the user's buddies. An example of this is shown as element 106 in FIG. 1. In this way, groups of friends may participate together, or compete against each other for points, as if they were all at the same physical location (and, in fact, may all be at the same physical location).

Additionally, messages may be provided to the user that are of general relevance to the episode but that are not otherwise based on users' interactions with the service. Using the golf example, the messages of general relevance may be statistics of participating golfers, gossip related to the golfers, or advertisements relating to golf or to the specific golf episode. In some instances, the information in the messages is retrieved from a database proprietary to the service and, in other instances, the information in the messages is retrieved from publicly-available databases (such as from web sites generally accessible via the world wide web).

FIG. 2 illustrates an example of a general architecture to implement the FIG. 1 example sports service. (In general, it may be considered that this architecture—and any other architecture described herein—may be platform independent.) Episode data 202 is provided corresponding to an episode 204, such as the golf championship 100 (FIG. 1). Indications 206 of the events are generated 208 based on processing the episode data 202. The generation 208 of event indications 206 may be achieved manually, automatically, or semi-automatically. For example, manual generation may include humans viewing the episode 204 live and then generating the event indications 206 as the episode 204 occurs. The manual generation may be based on a predefined framework.

Automatic generation may include the use of sensors that generate raw sensor episode data 202 based on the episode 204, and the raw sensor episode data 202 being processed 208 to generate the event indications 206. In some examples, the raw sensor episode data processing occurs automatically using, for example, known smart categorization engines (fully automatic system) or semi-automatically, with human assistance.

Examples of such sensors useable to generate raw sensor episode data 202 include positional sensors and visual sensors. Positional sensors (for example, employing the global positioning system) may be attached to vehicles, objects, and players involved in the episode, to detect their spatial coordinates. Virtual Spectator, Inc., of New Zealand, is a company that provides such sensors. For some episodes (such as relating to baseball, golf, or soccer, that primarily involve human players) it may be more appropriate to use a vision sensor system, such as a camera. Sport Universal, of France, is a company that employs vision sensors to track participants and objects (such as a ball) for sports events.

Referring still to FIG. 2, the generated event indications 206 are provided to an IM bot 210. The IM bot 210 is, for example, a program executing on one or more computers to determine to which users information about the events is to be directed. The IM bot 210 processes the event indications 206 and, based thereon, publishes information 212 corresponding to the event indications 206 to users 214 (for example, via active IM connections corresponding to those associated users). The form of the published information 212 and the particular active connections may depend, in part, on characteristics of the users 214. Examples of such characteristics include the platforms (e.g., cellular telephones, PDA's, tablets, laptops, and desktops which may have, for example, various screen sizes, processing speeds, and other characteristics) utilized by the IM users 214 and the manner by which the users 214 are connected to the IM service.

Certain processing is, in some examples, common to each bot 210. For example, when a user associates with the IM bot 210, information about the user is stored in an area accessible by the IM bot 210. Furthermore, the IM bot 210 reports the existence of the user to the other current associated users that have the new entrant user in their buddy list. Each bot 210 also processes interactive commands and maintains state information for each of the users. In addition, in some examples, the users may interact with the bot 210 to maintain a profile that indicates either or both of what and/or how much information the user provides to the bot 210 may be provided to other users and how (e.g., based on content, frequency, or other characteristics) the bot 210 interacts with the user.

Besides the common processing, each IM bot 210 performs particular processing, appropriate to its function. In the case of an example play-by-play sports service such as described with reference to FIG. 1, the IM bot 210 includes processing to process point bets from users. While this may be whether the current player will meet par for golf, in baseball, this may be whether the current batter will get to first base or strike out. A command provided to the IM bot 210 is particularly interpreted by the IM bot 210 according to the current service attached to the user. The IM bot reacts to the command based on the interpretation. For example, the IM bot 210 may update the internal user profile with a new score count or communicate with (or operate in conjunction with) another system (e.g. an online ticket retailer) to cause an action to be accomplished corresponding to the command.

By correlating the episodes with each user's online social environment, the experience of the users is enhanced. The correlation provides increased awareness of buddies, while simultaneously integrating interesting content to facilitate social interaction.

In accordance with some examples, the association is carried out with user information provided by a global database service such as the net service from Microsoft, or using other globally available user information such as, for example, profile information maintained by Amazon.com or other online shopping services.

In accordance with some examples, an association with a service occurs without any specific action on the user's part to effect the association. For example, a set top box of the user may automatically communicate with a bot 210 when the user switches to (or stays on) a particular television channel to associate the user with the bot corresponding to the episode being broadcast on the channel (perhaps using the net or other profile). As another example, a digital video recorder may automatically communicate with a bot 210 to associate the user with the bot 210 when the digital video recorder is playing back a particular program associated with the bot 210.

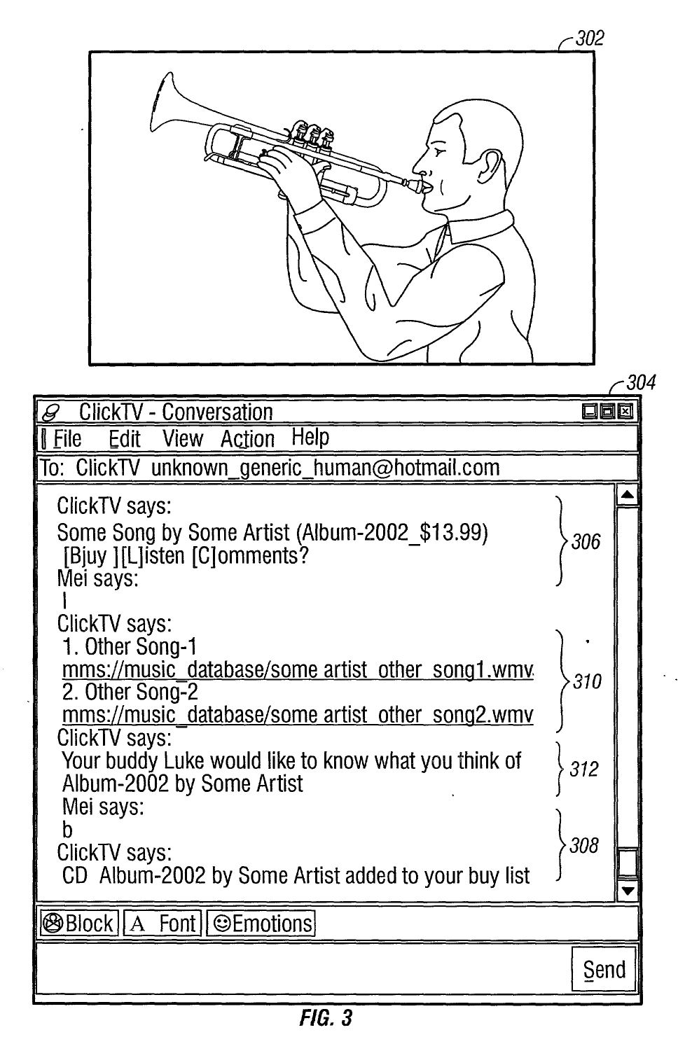

Now a shopping service example is discussed with reference to FIG. 3. Shopping is a very popular social activity. In addition to (or instead of) correlating services to episodes as, for example, described above, the sale (or other provision of) products and services is correlated to episodes in accordance with some examples. FIG. 3 illustrates a specific example, in which a music channel 302 over which music videos or a live music concert is played. An “event” in this case may correspond to a particular song, for example. The IM session 304 is synched to the music channel 302. As a song is played, information about the song is provided to the IM session 304 (see element 306) and the user has options to interact. Examples of the options to interact include buying the associated music CD (see element 308), listening to related songs (see element 310) and getting comments from buddies (see element 312). Other services provided in accordance with some examples include a news service, to provide information about the musical artists, trivia games relating to the music and/or artist (for example, in which viewers answer questions about the current artist and compete with each other for prizes) and live auctions.

In accordance with some examples of the shopping service, the architecture employed is similar to that shown for the sports example described above with reference to FIG. 1. With a music channel, though, the music is often pre-scheduled. This can simplify the event indication generation process because the event indications can be generated based on a provided schedule. Some examples generate the event indications based on voice recognition or image processing (e.g., OCR) technologies on the episode data (which is useful, for example, if schedule information is unavailable). Similar to the discussion above with reference to FIG. 2, the event indications are processed and corresponding information is provided to users via IM.

Specific processing corresponding to the music channel episodes may include, for example, processing of commands from users to purchase and experience various products related to the music. In some examples, when a user initiates a buy operation (by the user sending an appropriate message to the IM bot), the IM bot operates in conjunction with an external system to accomplish that operation. For example, to accomplish the sale of a CD, the IM bot may interact with an online music retailer. Similarly, to accomplish a live auction, the IM bot may interact with an auction system. In some examples, the Net web services architecture from Microsoft Corporation of Redmond, Wash., may be used as an underlying technology to tie together these different systems.

The activity-based shopping service focuses exposure to goods and services on consumers who are likely to have an interest in such goods and services. In addition, in accordance with some examples, the service provides users the ability to poll buddies to gather opinions (and, perhaps, even “show-off”) before initiating a purchase. In other examples, the bot provides messages to the user based on messages received from, and transactions with, other users. For example, if a particular user initiates a transaction to purchase a particular garment, the bot may provide messages to that user indicating related purchases by other users (such as whether and which other users have bought the garment, in what colors, etc.) In accordance with other examples, users compete via the service to purchase limited edition goods through a live-bid auction service. The shopping service may be non-intrusive to enable passive interaction. That is, a user may simply “sit back,” let messages from the IM bot scroll by, and only participate when desired. When the user does participate, the relevant information and services are readily available and easily accessible.

In accordance with another example, the collaborative interactive service synchronized to reality events includes a file swapping service, and event messages include file swapping messages.

In accordance with some examples, the episode (for example, as designated by reference numeral 204 in FIG. 2) is not actual reality but, rather, is virtual reality. For example, the introduction of console boxes (e.g., the PlayStation from Sony Corporation, of Japan; the Xbox from Microsoft Corporation; and the Gamecube from Nintendo, of Japan) has brought a convergence between the internet, television, and gaming. These console boxes are popular and have promoted gaming to a large number of users. In a general sense, game players are engaged within a virtual setting or virtual world to participate individually or in groups to achieve various objectives. Examples of virtual worlds include training simulations, historic episodes like WWII, fantasy games of dungeons and dragons, and simulations of real life. Advances in graphics technology enable virtual worlds that appear very realistic (for example, with respect to image rendering quality, character motions, and simulating such physical phenomena as gravity and collisions).

Many current virtual worlds have a built-in chat interface, but that interface is localized to within the game or to only certain areas within the game. Users may be required to learn a new chat interface for each virtual world they join, and a user's social network is thus typically limited to friends who are only in the same world. A common online social infrastructure such as IM ties together episodes from actual reality and from virtual reality. In accordance with some examples, users' social networks always include all of their online correspondents, regardless of the activity or world in which those correspondents are engaged.

In summary, the synchronization of IM to episodes simplifies the provision of iTV services to consumers, on infrastructure that is already deployed and popular. A particular feature of IM is that the IM service retains a log of messages that is accessible to the user. Thus, a user can go back and see previous messages that he may have ignored at the time the message was originally sent but to which he now wishes to respond. An example of such a response is initiating an online purchase.

In accordance with some examples, the bot maintains a database of responses provided by users and the association of the responses to the events (e.g., the association of the responses with the messages provided by the bot to the user). The database may be processed by, for example, well-known methods to discern information such as consumer preferences.

There are other collaborative interactive services. For example, the “reality content” may be a television shopping channel, and the IM messages between the corresponding bot and the users may be messages relevant to the products being displayed. As another example, a collaborative interactive service may be a collaborative learning service. In accordance with one such collaborative learning service, the “reality content” is an educational television program or other educational medium. The IM messages between the corresponding bot and the users include content relevant to the education television program content; personal information based on the user student's location; voting messages from the user student; questions (from the bot), answers (from the user) and a ladder of scores; open questions inviting collaborative responses from a plurality of associated users; and messages to engage the users in collaborative projects and/or field trips.

While examples and applications have been shown and described, many more modifications than mentioned above are possible without departing from the inventive concepts particularly described herein. The invention, therefore, is not to be restricted except in the spirit of the appended claims. For example, while IM provides a particular ubiquitous networked communication environment, there are other networked communication environments (whether now known or yet to be adopted) wherein groups of users are in communication with each other (as just some examples, communication using SMS, or web chat), and inventive concepts particularly described herein may be employed with these other networked communication environments.

1. A collaborative interactive service, comprising:
a) automatically generating and providing event messages to a plurality of particular user devices via a networked communication environment, based on events of a subset of particular episodes of a plurality of episodes and based on one or more social contexts of users in the networked communication environment, wherein at least one of the one or more social contexts of users is independent of the subset of particular episodes; and
b) receiving user messages from the particular user devices via the networked communication environment, responsive to the generated event-based messages, and correlating the received user messages to the events.

2. The service of claim 1, further comprising:
c) processing the user messages received and generating and providing messages based thereon via the networked communication environment.

3. The service of claim 2, further comprising:
d) processing transactions based on the user messages received.

4. The service of claim 1, wherein step c) includes processing the user messages received based, in part, on profiles associated with the users from whom the messages are received.

5. The service of claim 4, wherein step c) includes generating and providing the messages based on profiles associated with users to whom the messages are provided.

6. The service of claim 5, wherein the profiles associated with users to whom the messages are provided include conditions under which those users desire to be provided the messages.

7. The service of claim 1, further comprising:
generating a database of the provided event messages;
receiving requests to retrieve event messages from the database; and
providing the requested event messages.

8. The service of claim 1, wherein the networked communication environment operates according to an instant messaging protocol.

9. The service of claim 1, wherein the networked communication environment operates according to an SMS protocol.

10. The service of claim 1, further comprising:
c) receiving, via the networked communication environment, association messages from the plurality of user devices; and
d) processing the association messages and determining at least in part therefrom the plurality of user devices and the subset of particular episodes messages from the plurality of user devices; and
d) processing the association messages and determining at least in part therefrom the plurality of user devices and the subset of particular episodes.

11. The method of claim 1, wherein:
in step a), the event messages are generated and provided based, in addition, on the user messages received and correlated in step b).

12. The service of claim 10, wherein:
in step c), the association messages are received from a set-top box and the particular episodes are episodes determined by user interaction via the networked communication environment with the set-top box.

13. The service of claim 10, further comprising:
e) providing messages to the user devices via the networked communication environment based on the determination, in step d), of the plurality of the user devices and the subset of particular episodes.

14. The service of claim 10, wherein:
in step d), the processing step further includes processing user buddy lists to determine the one or more social contexts of users.

15. The service of claim 14, wherein:
in step d), processing user buddy lists includes determining the particular users on a buddy list for the user associated with a particular association message and who are associated with the subset of particular episodes.

16. The service of claim 15, and further including announcing the user associated with the particular association message to the particular users determined to be on the buddy list.

17. The service of claim 13, wherein:
in step e), the messages are selectively provided based on an indication received from a user device of a particular episode.

18. The service of claim 13, wherein:
in step a), the event messages further comprise information of general relevance to the particular episodes but not specifically based on events.

19. The service of claim 18, further comprising:
accessing a generally accessible database to retrieve the information of general relevance to the particular episodes; and
generating the event messages comprising the information of general relevance.

20. The service of claim 1, wherein the event messages comprise messages related to transactions relevant to the events.

21. The service of claim 20, wherein the event messages include links to online services.

22. The service of claim 21, wherein the online services include retail services.

23. The service of claim 21, wherein the online services include auction services.

24. The service of claim 20, wherein the event messages include message for file swapping.

25. The service of claim 20, wherein the event messages include audio messages.

26. The service of claim 20, wherein the event messages include video messages.

27. The service of claim 1, wherein:
the event messages are messages soliciting wagers relating to the events; and
the user messages are messages indicating desired wagers.

28. The service of claim 27, wherein the event messages soliciting wagers relating to the events include an indication of wagers made by the users.

29. The service of claim 1, wherein:
the user messages are messages initiating desired transactions.

30. The service of claim 29, further comprising:
completing the desired transactions without further interaction with the user.

31. The service of claim 29, further comprising:
completing the desired transactions with further interaction with the user via the networked communication environment.

32. The service of claim 1, wherein:
the events are actual events.

33. The service of claim 1, wherein:
the events are virtual events.

34. The service of claim 1, wherein:
the events are actual events and virtual events.

35. The service of claim 1, further comprising:
maintaining a database indicating the correlation of the received user messages to the events;
processing the database and providing information based thereon.

36. The service of claim 35, wherein the information provided based on processing the database includes consumer preferences for the users.

37. The service of claim 1, wherein:
a particular episode is an educational episode.

38. The service of claim 37, wherein:
the event messages are based on particular characteristics of the user.

39. The service of claim 38, wherein:
the particular characteristics of the user include the location of the user.

40. The service of claim 37, wherein:
the event messages are questions; and
the user messages are answers to the questions.

41. The service of claim 37, wherein:
the event messages related to collective characteristics of a plurality of the users.

42. The service of claim 41, wherein:
the event messages comprise a poll.

43. The service of claim 42, wherein:
the user messages comprise votes responsive to the poll.

44. A collaborative interactive system, comprising:
a) means configured to automatically generate and provide event messages to a plurality of particular user devices via a networked communication environment, based on events of a subset of particular episodes of a plurality of episodes and based on one or more social contexts of users, wherein at least one of the one or more social contexts of users is independent of the subset of particular episodes; and
b) means configured to receive user messages from the particular user devices via the networked communication environment, responsive to the generated event-based messages, and correlate the received user messages to the events.

45. The system of claim 44, further comprising:
c) means configured to process the user messages received and generate and provide messages based thereon via the networked communication environment.

46. The system of claim 45, further comprising:
d) means configured to process transactions based on the user messages received.

47. The system of claim 44, wherein means c) includes means configured to process the user messages received based, in part, on profiles associated with the users from whom the messages are received.

48. The system of claim 47, wherein means c) includes means configured to generate and provide the messages based on profiles associated with users to whom the messages are provided.

49. The system of claim 44, wherein the networked communication environment operates according to an instant messaging protocol.

50. The system of claim 44, wherein the networked communication environment operates according to an SMS protocol.

51. The system of claim 44, wherein the event messages comprise messages related to transactions relevant to the events.

52. The system of claim 51, wherein the event messages include links to online services.

53. The system of claim 52, wherein the online services include retail services.

54. The system of claim 52, wherein the online services include auction services.

55. The system of claim 44, wherein:
the user messages are messages initiating desired transactions.

56. The system of claim 55, further comprising:
means configured to complete the desired transactions without further interaction with the user.

57. The system of claim 55, further comprising:
means configured to complete the desired transactions with further interaction with the user via the networked communication environment.

58. A collaborative interactive service, comprising:
a) monitoring messages sent between particular user devices of users, of one or more social contexts of users, via a networked communication environment; and
b) automatically generating and providing event messages to the particular user devices via the networked communication environment, based on events of a subset of particular episodes of a plurality of episodes and based on the monitored messages.

59. The service of claim 58, further comprising:
c) receiving user messages from the particular user devices via the networked communication environment, responsive to the generated event-based messages, and correlating the received user messages to the events
d) processing the user messages received and generating and providing messages based thereon via the networked communication environment.

60. The service of claim 58, wherein step d) includes processing the user messages received based, in part, on profiles associated with the users from whom the messages are received.

61. The service of claim 60, wherein step d) includes generating and providing the messages based on profiles associated with users to whom the messages are provided.

62. The service of claim 58, further comprising:
c) receiving, via the networked communication environment, association messages from the plurality of user devices; and
d) processing the association messages and determining at least in part therefrom the plurality of user devices and the subset of particular episodes.

63. The service of claim 58, further including:
processing user buddy lists to determine the one or more social contexts of users.

64. The service of claim 62, wherein step d) includes:
processing user buddy lists to determine the particular users on a buddy list for the user associated with a particular association message and who are associated with the subset of particular episodes.

65. The service of claim 58, wherein:
in step b), the event messages further comprise information of general relevance to the particular episodes but not specifically based on events.

66. The service of claim 58, wherein the event messages comprise messages related to transactions relevant to the events.
